(19) United States
(12) Patent Application Publication
(10) Pub. No.: US 2004/0010850 A1
(43) Pub. Date: Jan. 22, 2004

(54) Coordinative lifting control method of bottom sections for lying furniture such as a bed

(76) Inventors: Hiroshi Nagaoka, Tokyo (JP); Masao Horitani, Tokyo (JP); Satoru Inoue, Tokyo (JP)

Correspondence Address: TOWNSEND & BANTA, P.C., Suite 900 South Building, 601 Pennsylvania Avenue N W, Washington, DC, 20005, US

(21) Appl. No.: 10/389,956

(22) Filed: Mar. 18, 2003

(30) Foreign Application Priority Data
Mar. 18, 2002 (JP) 2002-75072

(51) Int. Cl. A61G 7/005

(52) U.S. Cl. 5/618

(57) ABSTRACT

A method of controlling the coordinative lifting of bottom sections of lying furniture such as a bed that has a back bottom section for lifting the back portion of a lying person and a knee bottom section for lifting his/her knee portion, in which the respective bottom sections can be lifted by the lifting mechanisms respectively provided for them, characterized in that when the back bottom section is pivotally rotated and lifted to be kept inclined from a flat state where all the bottom sections are kept down to lie flat, at first, the lifting of the knee bottom section is started, and that at a time instant adequately later than the time instant when the lifting of the knee bottom section is started, the lifting of the back bottom section is started to ensure that both the bottom sections are lifted up to the respectively preset positions in an coordinative manner.

### FIELD OF THE INVENTION

The present invention generally relates to an coordinative lifting control method of bottom sections for lying furniture such as a bed (hospital bed, ICU bed, long term care bed, etc.) or a stretcher. In more detail, it relates to an coordinative lifting control method for lifting a back bottom section for lifting the back portion of a lying person and a knee bottom section for lifting his/her knee portion in an coordinative manner for achieving the following object, on lying furniture having the back bottom section and the knee bottom section.

### BACKGROUND OF THE INVENTION

Some of lying furniture such as beds and stretchers are respectively provided with a back bottom section for lifting the back portion of a lying person and a knee bottom section for lifting his/her knee portion, which can be respectively lifted by lifting mechanisms respectively provided for them.

Many examples of such lying furniture can be seen in U.S. Pat. Nos. 5,469,591, 5,448,789, 5,388,290, etc.

For example, the bed described in U.S. Pat. No. 5,469,591 has a back bottom section for lifting the back portion of a lying person, a knee bottom section for lifting his/her knee portion, and other bottom sections. On the undersides of the back bottom section and the knee bottom section, lifting arms each having a roller at the tip are installed pivotally rotatably, and the lifting arms can be driven and rotated by electric drive mechanisms such as motors.

In this constitution, the lifting arm of the back bottom section is pivotally rotated to let its roller lift the back bottom section in a pivotally rotating motion, for making it inclined, thereby lifting the back of the lying person, so that he/she can get up on the bed.

When the back bottom section is lifted and inclined like this, the lifting arm of the knee bottom section is pivotally rotated to let its roller lift the knee bottom section in a pivotally rotating motion, for making it inclined, thereby effectively preventing that the lying person slides forward if the back bottom section only is lifted.

That is, in the case where the person lying on the bed is lifted at his/her back, to get up, if the back bottom section is lifted, his/her body gradually slides forward since he/she is pressed forward at his/her back by the back bottom section. As a result, the point at which his/her body can be easily bent shifts from the pivot of the back bottom section. So, a force for bending the lumbar vertebra portion unlikely to be bent is applied from the back bottom section, to press the lumber vertebra portion and the abdominal portion of the lying person, making him/her feel displeasure.

Therefore, if the knee bottom section is lifted when the back bottom section is lifted, the body portion located above the inclined knee bottom section, i.e., femoral regions can receive the force applied from the back bottom section to press the lying person forward. As a result, the body sliding and displeasure feeling caused when his/her back only is lifted by means of the back bottom section can be prevented.

The conventional methods for also lifting the knee bottom section when lifting the back bottom section include, for example, the following.

a. As a first example, the drive mechanisms for lifting the back bottom section and the knee bottom section are operated respectively independently, and the lying person per se or a nurse simultaneously or alternately turns on and off the respective drive mechanisms, using, for example remote control switches, to lift the back bottom section and the knee bottom section respectively to desired positions.

b. As a second example, a common motor or the like is used to drive the drive mechanisms of the back bottom section and the knee bottom section using an interlocking mechanism such as a link mechanism, so that the drive mechanisms of the back bottom section and the knee bottom section can be actuated in a mechanically interlocked manner, to lift the back bottom section and the knee bottom section to predetermined positions.

(Problems of the Prior Art)

However, these conventional methods have the following problems.

A. In the method a, the lying person or a nurse must simultaneously or alternately operate the respective drive mechanisms of the back bottom section and the knee bottom section. This operation is very complicated and troublesome, and the operator must be accustomed to it. Furthermore, it is difficult to always reproduce the optimum lifting states respectively for the back bottom section and the knee bottom section.

B. In the method b, since an interlocking mechanism is used, the lifting states of the back bottom section and the knee bottom section achieved in an interlocked manner are inevitably simple and impossible to change, and it is difficult to efficiently prevent both the body sliding and the displeasure feeling such as pressure feeling.

### SUMMARY OF THE INVENTION

This invention has been achieved in view of the above-mentioned problems. It provides lying furniture such as a bed that has a back bottom section for lifting the back portion of a lying person and a knee bottom section for lifting his/her knee portion, in which the respective bottom sections can be lifted by the lifting mechanisms respectively provided for them, wherein when the back bottom section is pivotally rotated and lifted to be kept inclined from a flat state where all the bottom sections are kept down to lie flat, both the body sliding and the displeasure feeling such as pressure feeling can be efficiently prevented.

The first subject matter of this invention described in claim 1 proposes a method of controlling the coordinative lifting of bottom sections of lying furniture such as a bed that has a back bottom section for lifting the back portion of a lying person and a knee bottom section for lifting his/her knee portion, in which the respective bottom sections can be lifted by the lifting mechanisms respectively provided for them, characterized in that when the back bottom section is pivotally rotated and lifted to be kept inclined from a flat state where all the bottom sections are kept down to lie flat, at first, the lifting of the knee bottom section is started, and that at a time instant adequately later than the time instant when the lifting of the knee bottom section is started, the lifting of the back bottom section is started to ensure that both the bottom sections are lifted up to the respectively preset positions.

In this method, when the back bottom section is pivotally rotated and lifted to be kept inclined from a flat state where all the bottom sections are kept down to lie flat, the lifting of the knee bottom section is started at first. Since the knee bottom section is lifted like this, the lifted knee bottom section supports the position of the waist of the lying person. Therefore, in this state, even if the lifting of the back bottom section is started to gradually make the back bottom section inclined steeply, the lying person is prevented from sliding forward.

If the lifting of the back bottom section and the lifting of the knee bottom section are continued further without control, the angle formed between the back bottom section and the knee portion becomes gradually smaller, and as a result, the abdominal region of the lying person is gradually bent, to let him/her feel a pressure.

However, in the first subject matter of this invention, the lifting of the knee bottom section is not continued further without control, but is continued only up to a preset position. So, it does not happen that the angle formed between the back bottom section and the knee bottom section becomes smaller than a certain angle. Therefore, it can be prevented that the abdominal region of the lying person is gradually bent between both the bottom sections to let him/her feel a pressure.

The second subject matter of this invention described in claim 2 proposes a method of controlling the coordinative lifting of bottom sections of lying furniture such as a bed that has a back bottom section for lifting the back portion of a lying person and a knee bottom section for lifting his/her knee portion, in which the respective bottom sections can be lifted by the lifting mechanisms respectively provided for them, characterized in that when the back bottom section is pivotally rotated and lifted to be kept inclined from a flat state where all the bottom sections are kept down to lie flat, at first, the lifting of the knee bottom section is started, and that at a time instant adequately later than the time instant when the lifting of the knee bottom section is started, the lifting of the back bottom section is started to ensure that the knee bottom section is lifted to the preset highest position and subsequently lowered while the back bottom section is lifted to a predetermined position in an coordinative manner.

In this method, the lifting of the back bottom section and the lifting of the knee bottom section are not continued further without control, but at the time instant when the back bottom section beginning to be lifted reaches a certain angle, the knee bottom section reaches the preset highest position and thereafter is lowered on the contrary. So, even if the back bottom section is gradually lifted till it reaches its highest position, the knee bottom section is lowered by then. So, it does not happen that the angle formed between the back bottom section and the knee bottom section becomes smaller than a certain angle. Therefore, it can be prevented that the abdominal region of the lying person is gradually bent between them to let him/her feel a pressure.

The third subject matter of this invention described in claim 3 proposes a method, according to the second subject matter, wherein when the knee bottom section is lifted to the preset highest position and subsequently lowered, it is lowered to a predetermined position, before the back bottom section reaches its predetermined lifted position. Furthermore, the fourth subject matter of this invention described in claim 4 proposes a method, according to the second subject matter, wherein the knee bottom section is lifted to the preset highest position and subsequently lowered, it is lowered to the lowest position, before the back bottom section reaches its predetermined lifted position.

The position of the knee bottom section lowered after reaching the highest position can be a flat position or any adequately lifted position, and can be adjusted.

The fifth subject matter of this invention described in claim 5 proposes a method, wherein the time instant when the lifting of the back bottom section is started later than the time instant when the lifting of the knee bottom section is started, and/or the time instant when the knee bottom section reaches its highest position is judged in reference to the time elapsed after the time instant when the lifting of the knee bottom section is started. The sixth subject matter of this invention described in claim 6 proposes a method, wherein the elapsed time can be preset.

In the case where the capacities of the drive sources such as motors for actuating the lifting mechanisms of the back bottom section and the knee bottom section are sufficiently larger than the forces necessary for lifting the back bottom section and the knee bottom section on which the load of the lying person acts, or in the case where the load is constant, since there is a constant correlation between the time elapsed after the time instant of actuating a lifting mechanism and the position of the corresponding lifted bottom section, the elapsed time easy to control can be used for the above-mentioned action control responding to the lifted position of the bottom section.

The seventh subject matter of this invention described in claim 7 proposes a method, wherein the time instant when the lifting of the back bottom section is started later than the time instant when the lifting of the knee bottom section is started, and/or the time instant when the knee bottom section reaches its highest position, is judged by a position detecting means for the knee bottom section. The eighth subject matter of this invention described in claim 8 proposes a method, wherein the lifted position of the knee bottom section to be referred to for judging the time instant when the lifting of the back bottom section is started, can be preset.

The position detecting means for the knee bottom section can be installed at the knee bottom section per se, or the lifting mechanism, or the drive source such as a motor, or any other adequate place.

### BRIEF DESCRIPTION OF THE DRAWINGS

FIG. 1 is a side view showing the entire form of a bottom in a state where all the bottom sections are kept down to lie flat.

FIG. 2 is a side view showing the entire form of a bottom in one phase in the lifting action, in the case where the method of controlling the coordinative lifting of bottom sections of this invention is applied to a bed.

FIG. 3 is a side view showing the entire form of a bottom in another phase in the lifting action, in the case where the method of controlling the coordinative lifting of bottom sections of this invention is applied to a bed.

FIG. 4 is a side view showing the entire form of a bottom in a further other phase in the lifting action, in the case where the method of controlling the coordinative lifting of bottom sections of this invention is applied to a bed.

FIG. 5 is a side view showing the entire form of a bottom in a still further other phase in the lifting action, in the case where the method of controlling the coordinative lifting of bottom sections of this invention is applied to a bed.

FIG. 6 is a side view showing the entire form of a bottom in a still further other phase in the lifting action, in the case where the method of controlling the coordinative lifting of bottom sections of this invention is applied to a bed.

FIG. 7 is a diagram showing an example of how the inclination angles of the back bottom section and the knee bottom section change in relation with the elapsed time, in the case where the method of controlling the coordinative lifting of bottom sections of this invention is applied.

### DETAILED DESCRIPTION OF THE PREFERRED EMBODIMENTS

The preferred embodiments of this invention are described below in more detail in reference to the attached drawings.

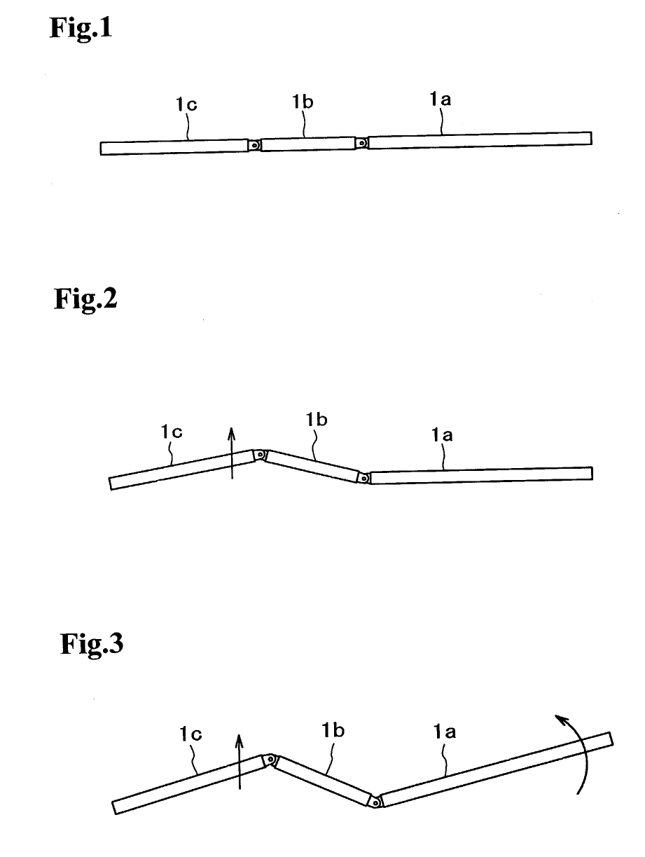

FIGS. 1 to 6 are side views each showing the entire form of a bottom in one phase in the lifting action, in the case where the method of controlling the coordinative lifting of bottom sections of this invention is applied to a bed.

The illustrated bed is composed of a back bottom section 1a for lifting the back portion of a lying person, a knee bottom section 1b for lifting his/her knee portion, and a leg bottom section 1c corresponding to his/her leg portion. The back bottom section 1a, the knee bottom section 1b and the leg bottom section 1c are connected with each other to form a bendable bottom corresponding to the whole body.

In the bed of this example, the bottom corresponding to the whole body is composed of the above-mentioned divided three bottom sections 1a, 1b and 1c connected with each other. However, the bottom can also be divided into four portions, or as described, for example, in the aforesaid U.S. Pat. Nos. 5,469,591, 5,448,789 and 5,388,290, many members can be connected with each other to form a bendable bottom. Anyway the bed to which this invention is applied is only required to have a back bottom section for lifting the back portion of a lying person and a knee bottom section for lifting his/her knee portion.

Furthermore, the lifting mechanisms for lifting the back bottom section 1a and the knee bottom 1b portion can be the mechanisms as described, for example, in the aforesaid U.S. Pat. Nos. 5,469,591, 5,448,789 and 5,388,290. That is, a lifting arm having a roller at the tip, which can be pivotally rotated by an electric drive mechanism such as a motor, can be installed to let the roller lift and support each bottom section, or a linear motion member with a rotary motion-linear motion conversion mechanism consisting of a threaded shaft and a female screw engaged with it can be connected with an arm installed on the underside of each bottom section.

The lifting mechanisms for lifting the back bottom section 1a and the knee bottom section 1b can be of course controlled to act in an coordinative manner as described later, or can also be controlled to actuate the respective bottom sections individually as required.

In this constitution, FIG. 1 shows a state where all the bottom sections 1a, 1b and 1c are kept down to lie flat, and in this state, a person such as a patient lies in an ordinary position. To let the lying person get up by lifting his/her back portion from this state, control switches are operated to issue commands to that effect to the means for controlling the lifting mechanisms.

In this invention, the control means receiving a first one of the commands actuates at first the lifting mechanism of the knee bottom section 1b as shown in FIG. 2, to start lifting the knee bottom section 1b only. The time instant when the lifting of the knee bottom section 1b is started is t=0 in FIG. 7.

Then, receiving the subsequent one of said commands, the control means starts lifting the back bottom section 1a at the time instant (t=T1) adequately later than the time instant when the lifting of the knee bottom section 1b is started, and thereafter as shown in FIG. 3, both the back bottom section 1a and the knee bottom section 1b are further lifted.

As described above, in this invention, for pivotally rotating and lifting the back bottom section 1a from a flat state where all the bottom sections are kept down to lie flat, at first the lifting of the knee bottom section 1b is started. Since the knee bottom section 1b is lifted, the knee bottom section 1b supports the position of the waist of the lying person, and therefore even if the lifting of the back bottom section is started in this state to gradually make the back bottom section steeply inclined, it can be prevented that the lying person is pressed at his/her back forward to slide forward.

If the lifting of the back bottom section 1a and the lifting of the knee bottom section 1b are continued further from the state of FIG. 3 without control, the angle formed between the back bottom section 1a and the knee bottom section 1b becomes gradually smaller to gradually bend the abdominal region of the lying person, finally letting him/her feel a pressure.

So, in this invention, the lifting of the knee bottom section 1b is not continued further without control, but if the knee bottom section 1b reaches a preset lifted position, it is not lifted any more.

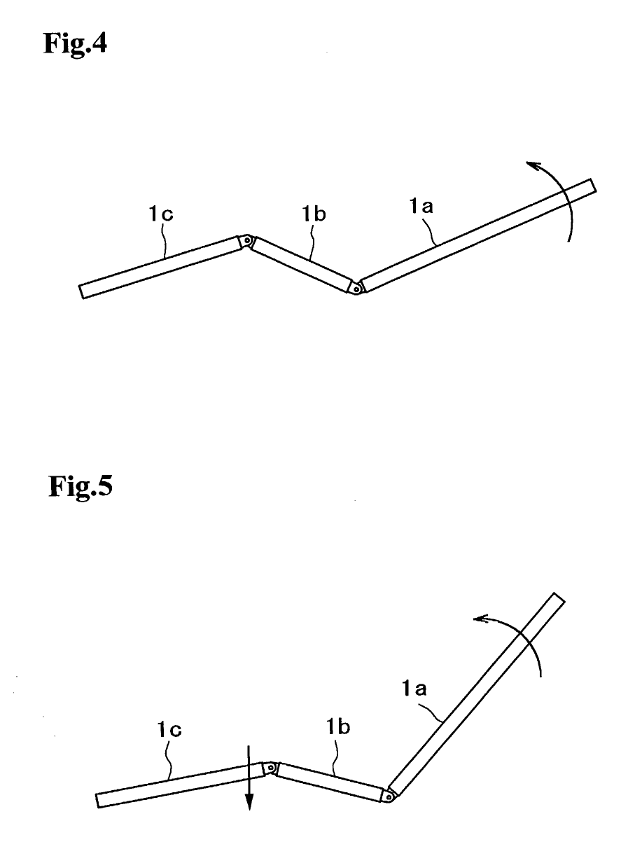

FIG. 4 shows this state as a concept. If the knee bottom section 1b reaches the preset highest position, the lifting of the knee bottom section 1b is stopped thereafter, and the lifting of the back bottom section 1a only is continued. In this coordinative operation, if the maximum angle of the knee bottom section 1b to the maximum angle of the back bottom section 1a is preset, it does not happen that the angle formed between the back bottom section 1a and the knee bottom section 1b becomes smaller than a certain angle.

Therefore, it can be prevented that the abdominal region of the lying person is gradually bent to let him/her feel a pressure.

The knee bottom section 1 that reaches the preset highest position (time instant of t=T2 in FIG. 7), hence the largest angle, can be controlled to maintain its position, but if it is controlled to decline from the highest position, a characteristic control action can be obtained as described below.

The control action is that, as shown in FIG. 7, after the knee bottom section 1b reaches the preset highest position (time instant of t=T2 in FIG. 7), the control means controls to let the lifting of the back bottom section 1b continue, but controls to lower the knee bottom section 1b. This control action is shown in FIG. 5 as a concept.

In this control action, even if the knee bottom section 1b is lifted further to have a larger angle at a certain time instant before the back bottom section 1a reaches its highest position, while the back bottom section 1a is further lifted to form a sharp angle, the angle of the knee bottom section 1b becomes gradually smaller. So, it does not happen either, that the angel formed between the back bottom section 1a and the knee bottom section 1b becomes smaller than a certain angle.

Therefore, in this control action, the effect of the knee bottom section 1b having a larger angle more positively prevents that the lifting of the back bottom section 1a presses the lying person at his/her back to let him/her slide forward, and it can be prevented that the abdominal region of the lying person is gradually bent between the back bottom section 1a and the knee bottom section 1b to let him/her feel a pressure.

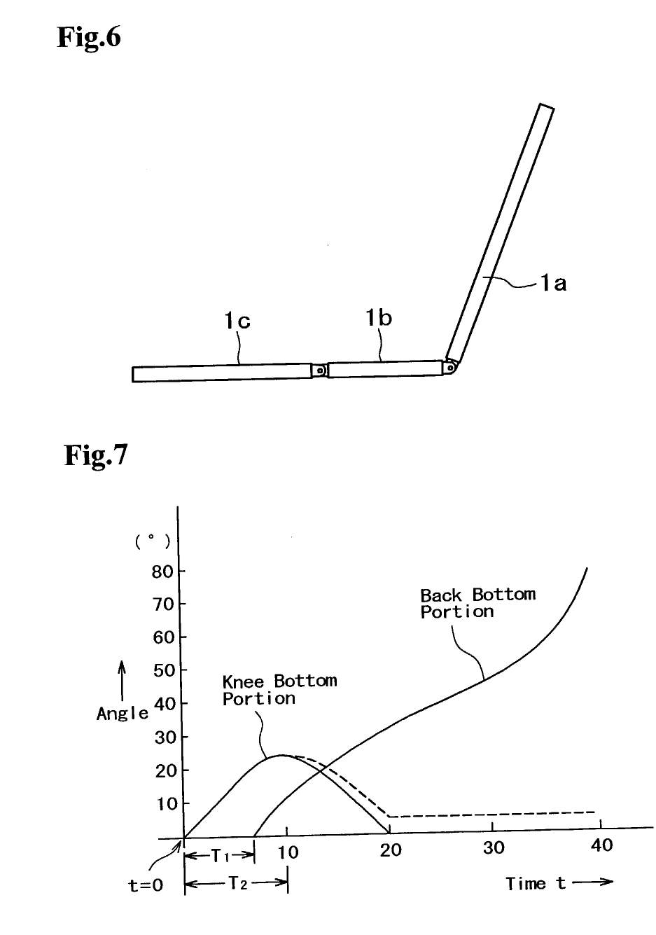

The position to be reached by the knee bottom section 1b lowered from its preset highest position can be adequately preset, depending on various conditions. In the example shown in FIG. 6 and by the solid line of FIG. 7, the knee bottom section 1b is lowered to be flat. On the other hand, in the example shown by the broken line of FIG. 7, the knee bottom section 1b is lowered to, for example, about 6°, and thereafter the angle is maintained.

Next, as a first method of detecting the time instant when the lifting of the back bottom section 1a is started (T=T1) later than the time instant when the lifting of the knee bottom section 1b is started (t=0), and/or the time instant when the knee bottom section 1b reaches its highest position (t=T2), to ensure that the control means can carry out the above-mentioned control action, the time elapsed from the time instant when the lifting of the knee bottom section 1b is started can be referred to for detecting said time instant.

In the case where the capacities of the drive sources such as motors for actuating the lifting mechanisms of the back bottom section 1a and the knee bottom section 1b are sufficiently larger than the forces necessary for lifting the back bottom section 1a and the knee bottom section 1b on which the load of the lying person acts, or in the case where the load is constant, there is a constant correlation between the time elapsed after the time instant of actuating a lifting mechanism and the position of the corresponding lifted bottom section 1a or 1b. So, the elapsed time easy to control can be used to carry out the above-mentioned control action in response to the lifted position of the bottom section 1a or 1b.

In this case, if it is ensured that the preset values of said time instants T1 and T2 in the control means can be changed, an adequate control action suitable for various conditions such as the person lying on the bottom can be carried out.

As a second method of detecting the time instant when the lifting of the back bottom section 1a is started (T=T1) later than the time instant when the lifting of the knee bottom section 1b is started (t=0), and/or the time instant when the knee bottom section 1b reaches its highest position (t=T2), to ensure that the control means can carry out the above-mentioned control action, a position detecting means such as an angle sensor can be installed for the knee bottom section 1b, for detecting the position. The position detecting means for the knee bottom section 1b can be installed at an adequate place, for example, the knee bottom section per se, the lifting mechanism or the drive source such as a motor.

Also in this case, if arrangement is made to ensure that the respective positions can be preset, an adequate control action suitable for various conditions such as the person lying on the bottom can be carried out.

The control action of the back bottom section 1a and the knee bottom section 1b to which this invention is applied has been described as an action in the case where the back bottom section is pivotally rotated and lifted to be kept inclined from a flat state where all the bottom sections are kept down to lie flat. The action in the case where all the bottoms are lowered to be flat from a lifted state where the back bottom section is pivotally rotated and lifted to be most inclined, is reverse to the action explained for the case of lifting. So, the explanation for the latter case of lowering is not made.

But in another embodiment, the action in the case where all the bottoms are lowered to be flat from a lifted state where the back bottom section is pivotally rotated and lifted to be most inclined, maybe different from the reverse action to the action explained for the case of lifting.

Also in the action for lowering, since the knee bottom section lifted to a certain position or the highest position is lowered thereafter, a similar action occurs when the knee bottom section is lowered. So, it can be prevented that the person lying on the bottom slides forward, and when the entire bottom becomes flat, the person lying on the bottom is not displaced. So, the trouble that the caregiver must return the lying person to the original position can be saved.

### INDUSTRIAL APPLICABILITY

As described above, the lying furniture such as a bed or stretcher of this invention has a back bottom section for lifting the back portion of a lying person and the knee bottom section for lifting his/her knee portion, and the respective bottom sections can be lifted by the lifting mechanisms installed respectively for them. In this lying furniture, when the back bottom section is pivotally rotated and lifted to be kept inclined from a flat state where all the bottom sections are kept down to lie flat, at first, the lifting of the knee bottom section is started, and at a time instant adequately later than the time instant of said start, the lifting of the back bottom section is started. Thereafter, the knee bottom section is maintained at its preset highest position or lowered after reaching the highest position, and the back bottom section is lifted to a predetermined position in an coordinative manner. Therefore, this invention exhibits the following effects.

a. When the back bottom section is pivotally rotated and lifted from a flat state where all the bottom sections are kept down to lie flat, at first, the lifting of the knee bottom section is started. Since the knee bottom section is lifted, the knee bottom section supports the position of the waist of the lying person. Therefore, even if the lifting of the back bottom section is started to make the back bottom section steeply inclined, it can be prevented that the lying person slides forward.

b. If the lifting of the back bottom section and the lifting of the knee bottom section are continued further without control, the angle formed between the back bottom section and the knee bottom section becomes gradually smaller. So, the abdominal region of the lying person is gradually bent between them, and he/she finally feels a pressure. However, in this invention, the lifting of the knee bottom section is not continued further without control, but is continued only till a preset position is reached. So, since the knee bottom section is maintained at the position or lowered thereafter, it does not happen that the angle formed between the back bottom section and the knee bottom section becomes smaller than a certain angle. Therefore, it can be prevented that the abdominal region of the lying person is gradually bent between them to let him/her feel a pressure.

c. If it is ensured that the time instant when the lifting of the back bottom section is started later than the time instant when the lifting of the knee bottom section is started, and/or the time instant when the knee bottom section reaches its highest position can be preset, an adequate control action suitable for various conditions such as the person lying on the bottom can be made.

1. A method of controlling the coordinative lifting of bottom sections of lying furniture such as a bed that has a back bottom section for lifting the back portion of a lying person and a knee bottom section for lifting his/her knee portion, in which the respective bottom sections can be lifted by the lifting mechanisms respectively provided for them, characterized in that when the back bottom section is pivotally rotated and lifted to be kept inclined from a flat state where all the bottom sections are kept down to lie flat, at first, the lifting of the knee bottom section is started, and that at a time instant adequately later than the time instant when the lifting of the knee bottom section is started, the lifting of the back bottom section is started to ensure that both the bottom sections are lifted up to the respectively preset positions.

2. A method of controlling the coordinative lifting of bottom sections of lying furniture such as a bed that has a back bottom section for lifting the back portion of a lying person and a knee bottom section for lifting his/her knee portion, in which the respective bottom sections can be lifted by the lifting mechanisms respectively provided for them, characterized in that when the back bottom section is pivotally rotated and lifted to be kept inclined from a flat state where all the bottom sections are kept down to lie flat, at first, the lifting of the knee bottom section is started, and that at a time instant adequately later than the time instant when the lifting of the knee bottom section is started, the lifting of the back bottom section is started to ensure that the knee bottom section is lifted to the preset highest position and subsequently lowered while the back bottom section is lifted to a predetermined position.

3. A method of controlling the coordinative lifting of bottom sections of lying furniture such as a bed, according to claim 2, wherein when the knee bottom section is lifted to the preset highest position and subsequently lowered, it is lowered to a predetermined position, before the back bottom section reaches its predetermined lifted position.

4. A method of controlling the coordinative lifting of bottom sections of lying furniture such as a bed, according to claim 2, wherein the knee bottom section is lifted to the preset highest position and subsequently lowered, it is lowered to the lowest position, before the back bottom section reaches its predetermined lifted position.

5. A method of controlling the coordinative lifting of bottom sections of lying furniture such as a bed, according to claim 1 or 2, wherein the time instant when the lifting of the back bottom section is started later than the time instant when the lifting of the knee bottom section is started, and/or the time instant when the knee bottom section reaches its highest position is judged in reference to the time elapsed after the time instant when the lifting of the knee bottom section is started.

6. A method of controlling the coordinative lifting of bottom sections of lying furniture such as a bed, according to claim 5, wherein the elapsed time can be preset.

7. A method of controlling the coordinative lifting of bottom sections of lying furniture such as a bed, according to claim 1 or 2, wherein the time instant when the lifting of the back bottom section is started later than the time instant when the lifting of the knee bottom section is started, and/or the time instant when the knee bottom section reaches its highest position, is judged by a position detecting means for the knee bottom section.

8. A method of controlling the coordinative lifting of bottom sections of lying furniture such as a bed, according to claim 7, wherein the lifted position of the knee bottom section to be referred to for judging the time instant when the lifting of the back bottom section is started, can be preset.
